(19) United States
(12) Patent Application Publication
(10) Pub. No.: US 2026/0210754 A1
(43) Pub. Date: Jul. 23, 2026

(54) FOLDABLE SCALE

(71) Applicant: MobileDemand LC, Hiawatha, IA (US)

(72) Inventors: Matthew D. Miller, Cedar Rapids, IA (US); Blayne E. Medema, Cedar Rapids, IA (US)

(21) Appl. No.: 19/446,473

(22) Filed: Jan. 12, 2026

Related U.S. Application Data
(60) Provisional application No. 63/746,577, filed on Jan. 17, 2025.

(51) Int. Cl. G01G 21/00

(52) U.S. Cl. CPC G01G 21/00

(57) ABSTRACT

A foldable scale may include arms. The arms may fold and unfold. The foldable scale may include a center core about which the arms may rotate for folding and unfolding. The arms and the center core may include load cells. The foldable scale may include a control unit which receives measurements from the load cells and sums the measurements to determine a total weight measurement of an object on the foldable scale.

### CROSS-REFERENCE

The present application claims the benefit under 35 U.S.C. § 119 of U.S. Provisional application 63/746,577, filed on Jan. 17, 2025, titled “FOLDABLE SCALE,” which is incorporated herein by reference in the entirety.

### TECHNICAL FIELD

The present disclosure generally relates to weighing, and more specifically to a portable weighing apparatus.

### BACKGROUND

Scales are used in warehousing and retail environments, where weight measurements are used for inventory management and shipping calculations. Bulkiness and fixed form factors restrict the mobility of the scales. Scales mounted on carts have been introduced to support mobility within warehouses. However, the scales mounted on carts take up a relatively large space and may slow the operator down when walking through the warehouse. Therefore, it would be advantageous to provide a device, system, and method that mitigates the shortcomings described above.

### SUMMARY

In some aspects, the techniques described herein relate to a foldable scale including: a plurality of arms including a first arm, a second arm, and a third arm; a center core, wherein the plurality of arms extend from the center core, wherein the first arm is affixed to the center core, wherein the second arm and the third arm are configured to independently rotate about the center core between an unfolded configuration and a folded configuration, wherein the plurality of arms form a Y-shape in the unfolded configuration, wherein the second arm and the third arm are adjacent to the first arm in the folded configuration; a plurality of load cells configured to generate a plurality of weight measurements, wherein the plurality of load cells extend from undersides of the plurality of arms and the center core; one or more batteries; and a control unit, wherein the control unit and the center core are disposed at opposing ends of the first arm, wherein the control unit is configured to receive the plurality of weight measurements and generate a total weight measurement from the plurality of weight measurements, wherein the control unit includes a display, wherein the display is configured to display the total weight measurement.

In some aspects, the techniques described herein relate to a system including: a foldable scale including: a plurality of arms including a first arm, a second arm, and a third arm; a center core, wherein the plurality of arms extend from the center core, wherein the first arm is affixed to the center core, wherein the second arm and the third arm are configured to independently rotate about the center core between an unfolded configuration and a folded configuration, wherein the plurality of arms form a Y-shape in the unfolded configuration, wherein the second arm and the third arm are adjacent to the first arm in the folded configuration; a plurality of load cells configured to generate a plurality of weight measurements, wherein the plurality of load cells extend from undersides of the plurality of arms and the center core; one or more batteries; a control unit, wherein the control unit and the center core are disposed at opposing ends of the first arm, wherein the control unit is configured to receive the plurality of weight measurements and generate a total weight measurement from the plurality of weight measurements, wherein the control unit includes a display, wherein the display is configured to display the total weight measurement; and a wireless communication interface; and a computing device, wherein the control unit is configured to establish a wireless connection with the computing device using the wireless communication interface by which the computing device is configured to receive the total weight measurement.

In some aspects, the techniques described herein relate to a bench scale including: a foldable scale including: a plurality of arms including a first arm, a second arm, and a third arm; a center core, wherein the plurality of arms extend from the center core, wherein the first arm is affixed to the center core, wherein the second arm and the third arm are configured to independently rotate about the center core between an unfolded configuration and a folded configuration, wherein the plurality of arms form a Y-shape in the unfolded configuration, wherein the second arm and the third arm are adjacent to the first arm in the folded configuration; a plurality of load cells configured to generate a plurality of weight measurements, wherein the plurality of load cells extend from undersides of the plurality of arms and the center core; one or more batteries; and a control unit, wherein the control unit and the center core are disposed at opposing ends of the first arm, wherein the control unit is configured to receive the plurality of weight measurements and generate a total weight measurement from the plurality of weight measurements, wherein the control unit includes a display, wherein the display is configured to display the total weight measurement; and a platform, wherein the platform is supported by the plurality of arms and the center core.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the description and drawings explain the principles of the disclosure.

### BRIEF DESCRIPTION OF THE DRAWINGS

Implementations of the concepts disclosed herein may be better understood when consideration is given to the following detailed description thereof. Such description makes reference to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1A depicts a front perspective view of a foldable scale in an unfolded configuration, in accordance with one or more embodiments of the present disclosure.

FIG. 1B depicts a right front perspective view of the foldable scale in the unfolded configuration, in accordance with one or more embodiments of the present disclosure.

FIG. 1C depicts a left front perspective view of the foldable scale in the unfolded configuration, in accordance with one or more embodiments of the present disclosure.

FIG. 1D depicts a front elevation view of the foldable scale in the unfolded configuration, in accordance with one or more embodiments of the present disclosure.

FIG. 1E depicts a right rear perspective view of the foldable scale in the unfolded configuration, in accordance with one or more embodiments of the present disclosure.

FIG. 1F depicts a rear elevation view of the foldable scale in the unfolded configuration, in accordance with one or more embodiments of the present disclosure.

FIG. 1G depicts a left rear elevation view of the foldable scale in the unfolded configuration, in accordance with one or more embodiments of the present disclosure.

FIG. 1H depicts a partial perspective view of a control unit of the foldable scale in the unfolded configuration, in accordance with one or more embodiments of the present disclosure.

FIG. 2 depicts a left front perspective view of foldable scale in a partially unfolded configuration, in accordance with one or more embodiments of the present disclosure.

FIG. 3A depicts a left front perspective view of the foldable scale in a folded configuration, in accordance with one or more embodiments of the present disclosure.

FIG. 3B depicts a right front perspective view of the foldable scale in the folded configuration, in accordance with one or more embodiments of the present disclosure.

FIG. 3C depicts a right rear perspective view of the foldable scale in the folded configuration, in accordance with one or more embodiments of the present disclosure.

FIG. 3D depicts a left rear perspective view of the foldable scale in the folded configuration, in accordance with one or more embodiments of the present disclosure.

FIG. 3E depicts a partial perspective view of the control unit covered by shrouds of the foldable scale in the folded configuration, in accordance with one or more embodiments of the present disclosure.

FIG. 4 depicts a top view of the control unit of the foldable scale, in accordance with one or more embodiments of the present disclosure.

FIG. 5A depicts a top view of a circuit of foldable scale, in accordance with one or more embodiments of the present disclosure.

FIG. 5B depicts a partial top view of the circuit at a center core of the foldable scale, in accordance with one or more embodiments of the present disclosure.

FIG. 5C depicts a partial top view of the circuit at the center core of the foldable scale, in accordance with one or more embodiments of the present disclosure.

FIG. 5D depicts a cross-section view of the center core of the foldable scale, in accordance with one or more embodiments of the present disclosure.

FIG. 5E depicts a perspective view of a wire guide disk of the center core of the foldable scale, in accordance with one or more embodiments of the present disclosure.

FIG. 6 depicts a perspective view of a holstered scale with a holster and the foldable scale, in accordance with one or more embodiments of the present disclosure.

FIG. 7A depicts a simplified block diagram of system with the foldable scale, in accordance with one or more embodiments of the present disclosure.

FIGS. 7B-7C depict perspective views of the system with the foldable scale, in accordance with one or more embodiments of the present disclosure.

FIG. 7D depicts a perspective view of the system with multiple of the foldable scales weighing one oversize object, in accordance with one or more embodiments of the present disclosure.

FIG. 7E depicts a perspective view of the system with multiple of the foldable scales weighing multiple objects, in accordance with one or more embodiments of the present disclosure.

FIG. 8A depicts a perspective view of a bench scale with the foldable scale, in accordance with one or more embodiments of the present disclosure.

FIG. 8B depicts a perspective view of the bench scale with the foldable scale supporting a dimensioning booth, in accordance with one or more embodiments of the present disclosure.

FIG. 8C depicts a perspective view of the bench scale with the foldable scale supported by a dimensioning booth, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details are set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

Reference will now be made in detail to the subject matter disclosed, which is illustrated in the accompanying drawings. Embodiments of the present disclosure are directed to a foldable scale. The foldable scale may include arms. The arms may fold and unfold. The foldable scale may include a center core about which the arms may rotate for folding and unfolding. The arms and the center core may include load cells. The foldable scale may include a control unit which receives measurements from the load cells and sums the measurements to determine a total weight measurement of an object on the foldable scale. The foldable scale may be used in various industries, such as, but not limited to, for warehousing, industrial weighing, and the like.

U.S. Design Pat. No. 699,611S1, titled “Triscale”; is incorporated herein by reference in the entirety.

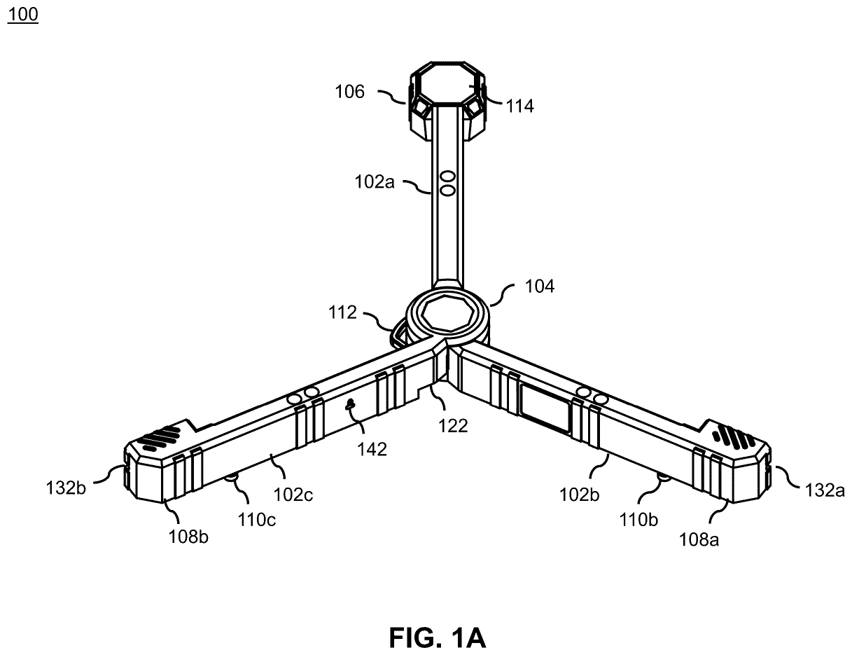

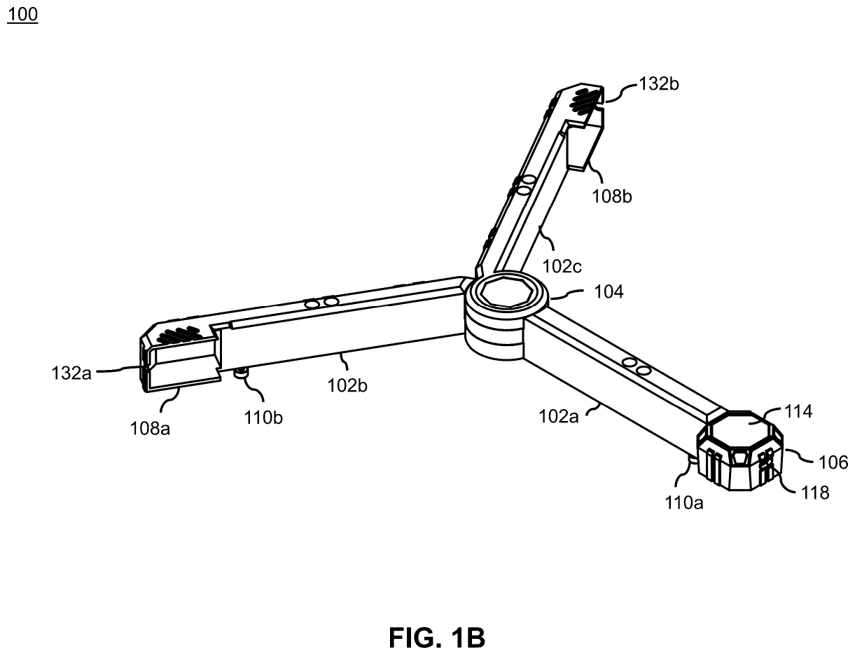

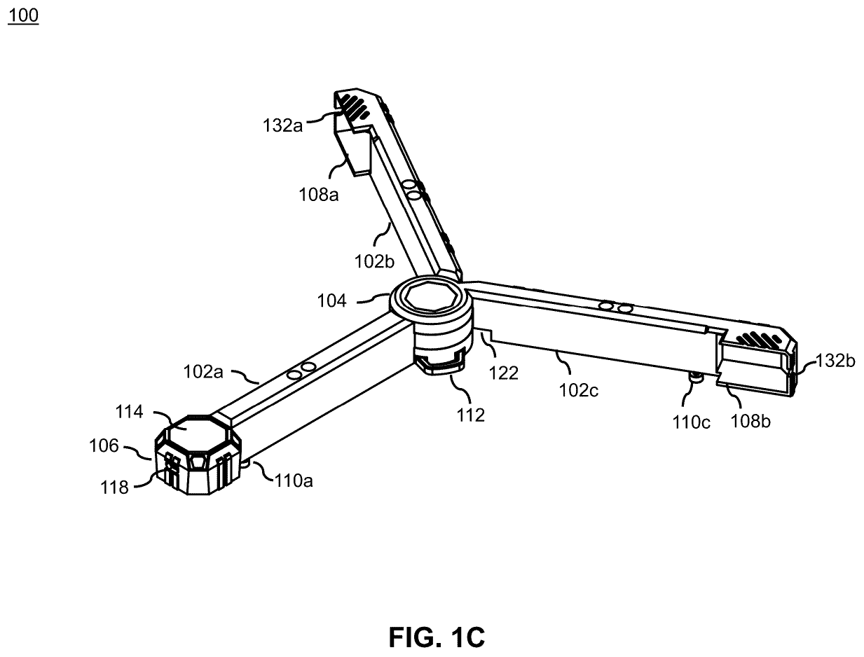

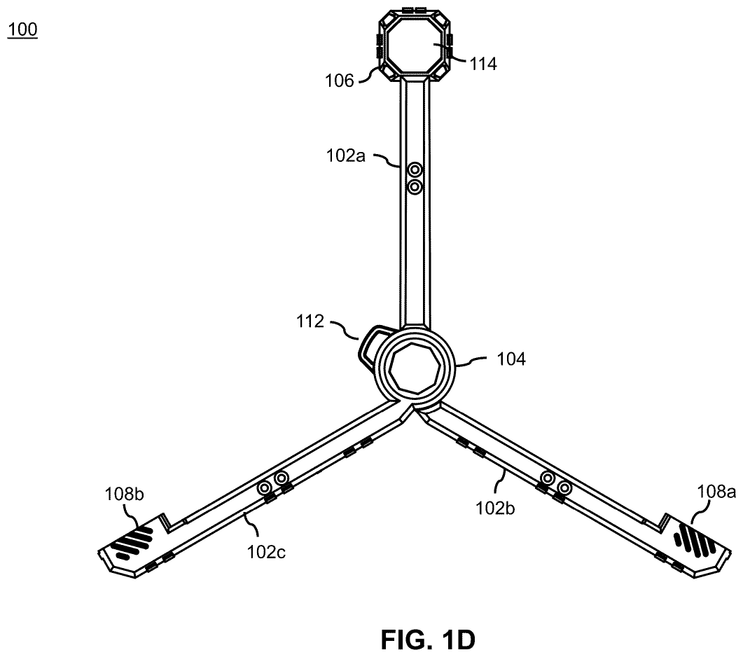

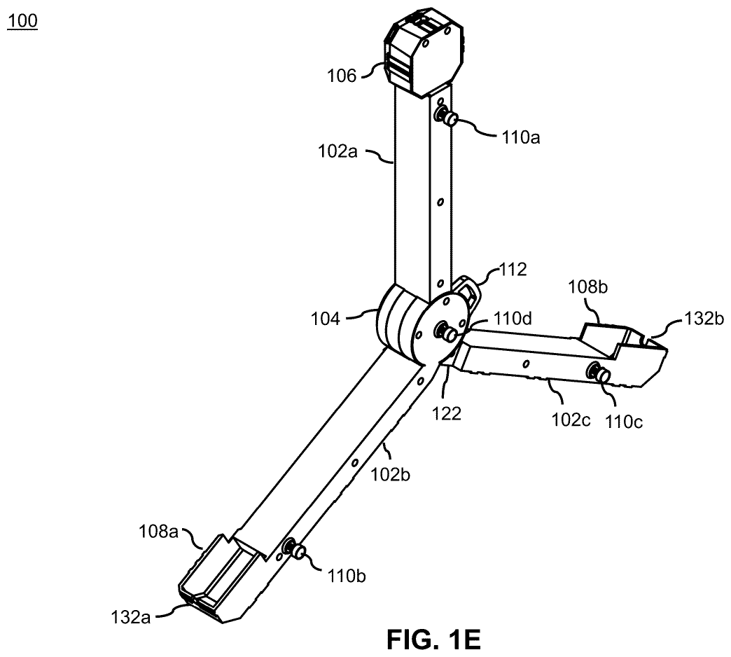

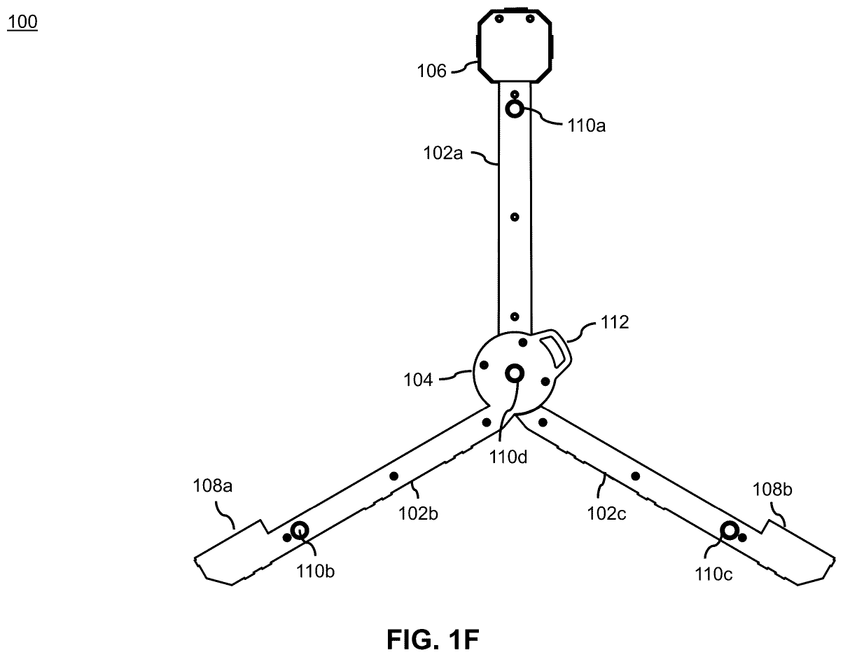

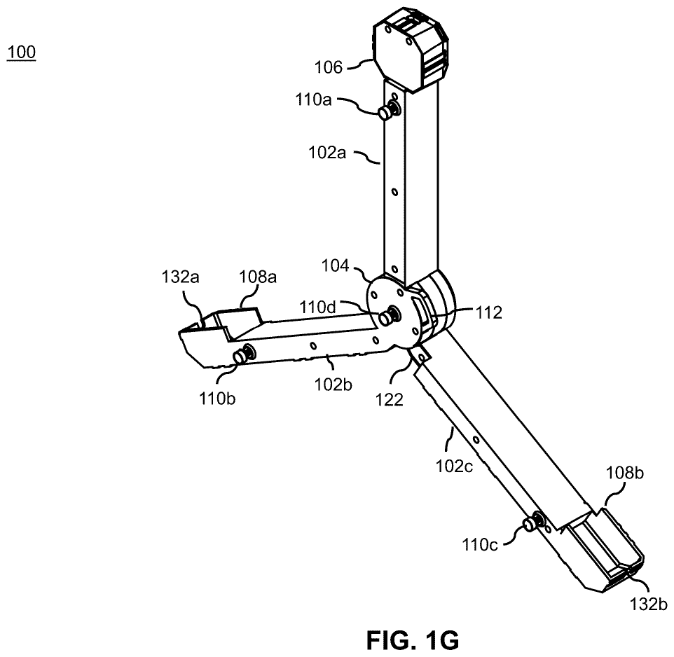

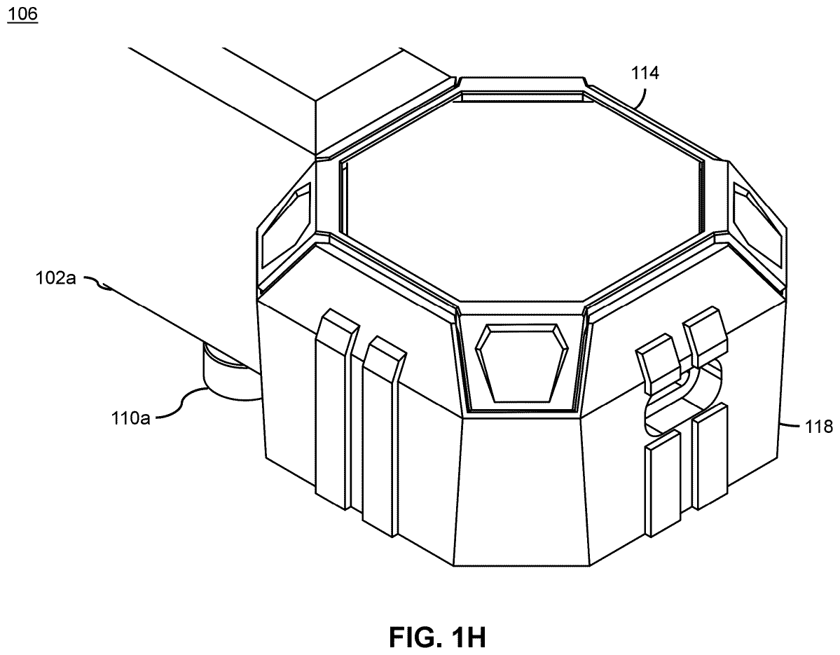

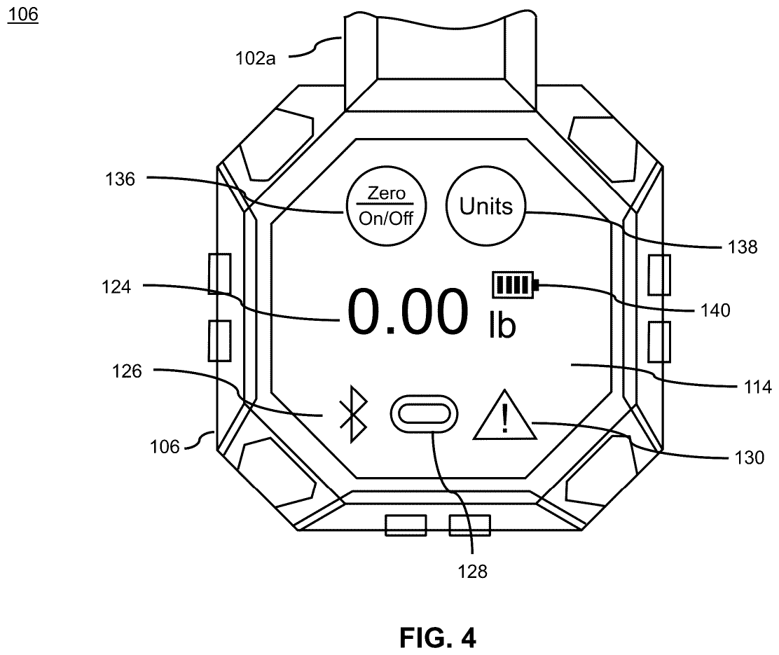

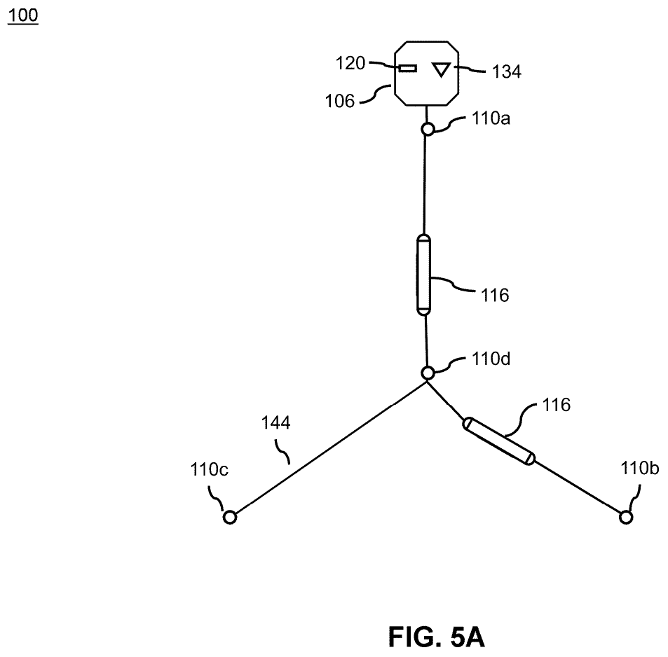

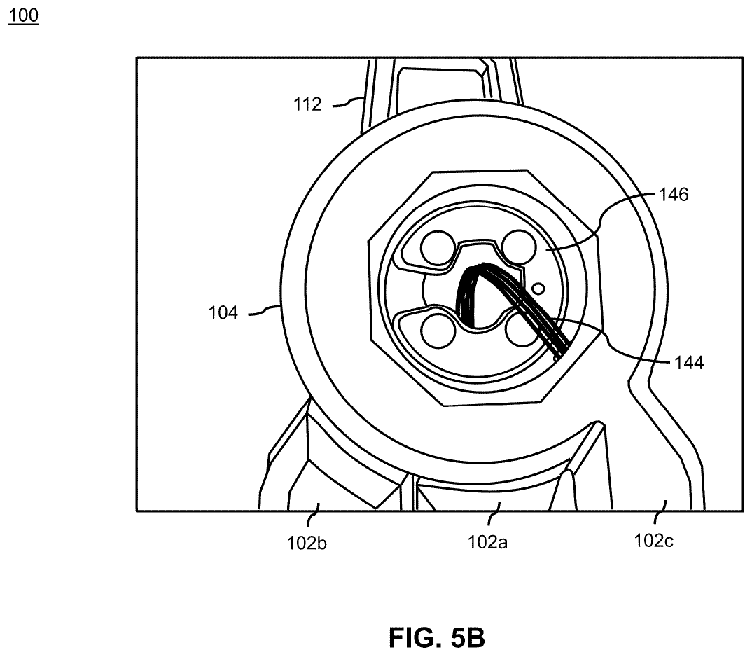

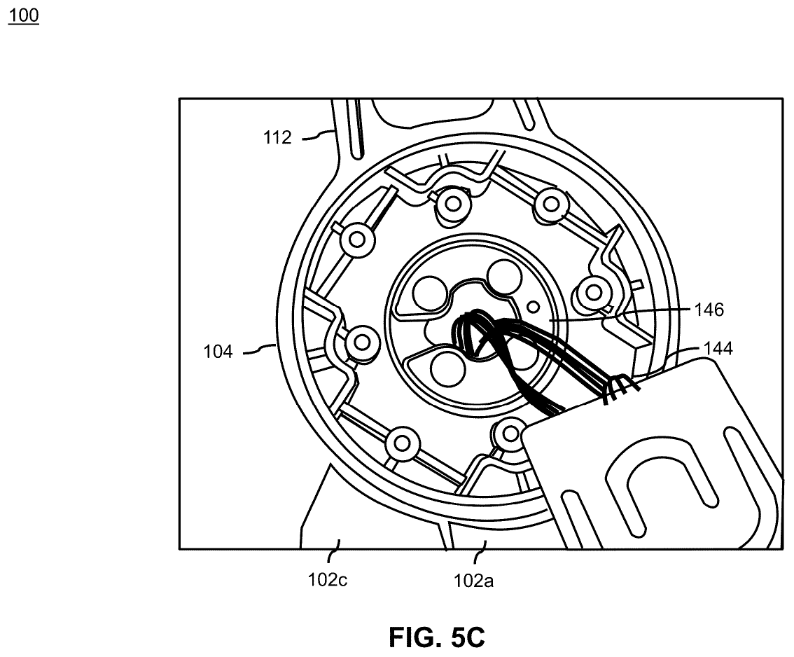

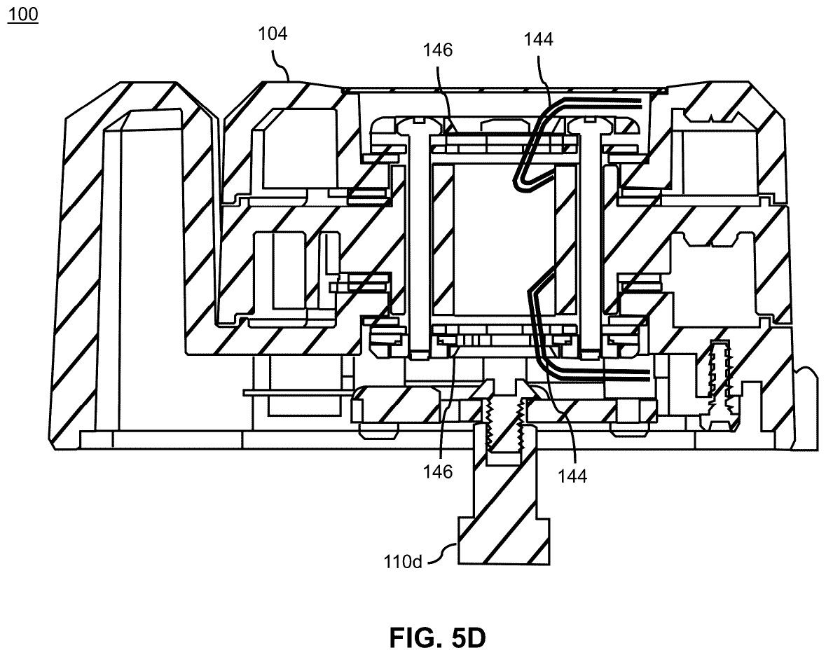

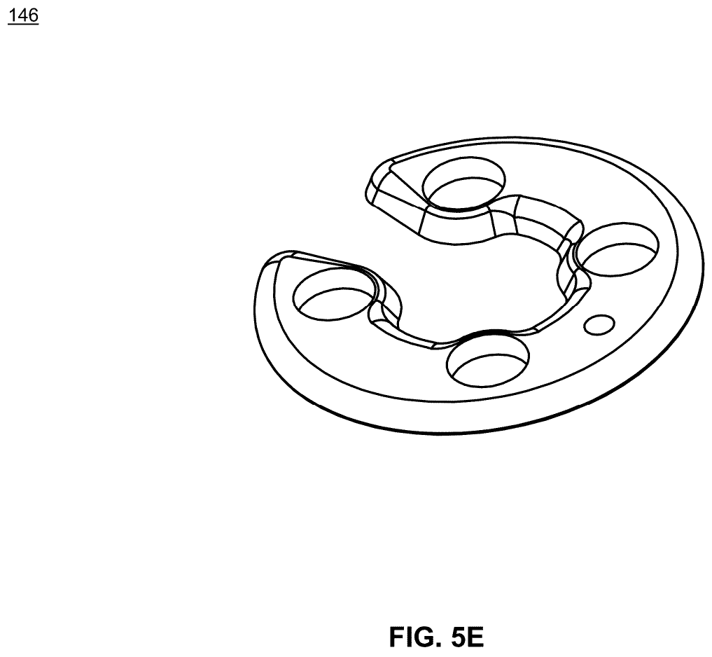

FIGS. 1A-5E depict a foldable scale 100, in accordance with one or more embodiments of the present disclosure. The foldable scale 100 may include arms 102, center core 104, control unit 106, shrouds 108, load cells 110, hook 112, display 114, batteries 116, charge port 118, sensor 120, and the like.

The arms 102 may also be referred to as legs. The foldable scale 100 may include three of the arms 102 (e.g., arm 102a, arm 102b, arm 102c). The foldable scale 100 may be a tri-armed scale or a tri-scale by including three of the arms 102. The arm 102a, the arm 102b, and the arm 102c may be referred to as a first arm, a second arm, and a third arm, respectively.

The center core 104 may include a cylindrical shape. The center core 104 may define a central axis of the foldable scale 100.

The arms 102 may extend from the center core 104. One or more of the arms 102 may be fixed to the center core 104 and/or one or more of the arms 102 may be configured to rotate about the center core 104. For example, the arm 102a may be fixed to the center core 104. By way of another example, the arm 102b and the arm 102c may be configured to rotate about the center core 104.

The arms 102 may be configured to rotate about the center core 104 between an unfolded configuration, a folded configuration, or a partially unfolded configuration between the unfolded configuration and the folded configuration. The arm 102b and the arm 102c may be configured to independently rotate about the center core 104 between the unfolded configuration, a folded configuration, or a partially unfolded configuration between the unfolded configuration and the folded configuration.

The unfolded configuration may also be referred to as an expanded configuration, a measurement configuration, or the like. The arm 102b and the arm 102c may be disposed at equidistant angles from each other in the unfolded configuration. For example, the arm 102a, the arm 102b, and the arm 102c may be disposed at 120° angles from each other in the unfolded configuration. The arm 102a, the arm 102b, and the arm 102c may form a Y-shape in the unfolded configuration. The Y-shape may include the arms 102 at the equidistant 120° angles. FIGS. 1A-1H depict the foldable scale 100 in the unfolded configuration.

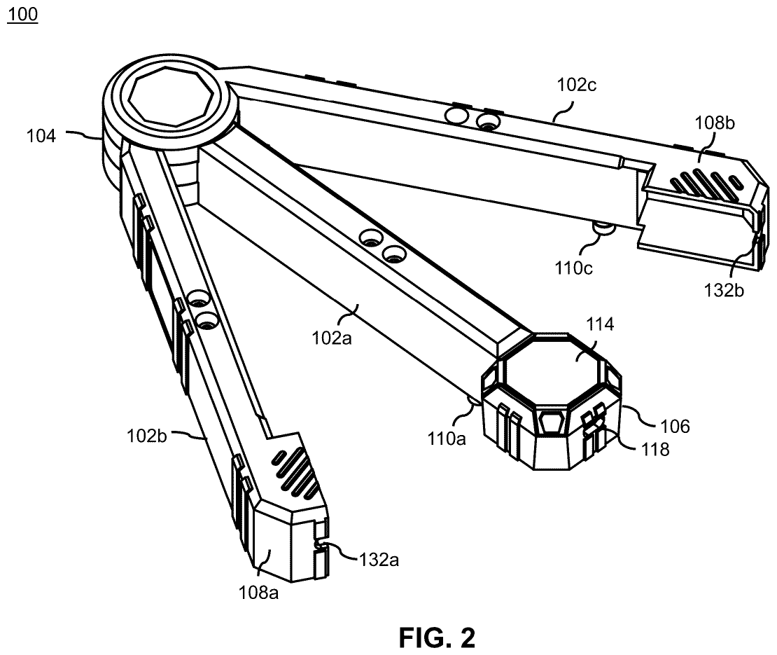

The partially unfolded configuration may also be referred to as a partially folded configuration. The arm 102b and the arm 102c may be disposed angles between the unfolded configuration and the folded configuration. For example, the arm 102b and the arm 102c may be disposed at any of various angles between abutting the arm 102a and being disposed at 120° angles from the arm 102a. FIG. 2 depicts the foldable scale 100 in the partially unfolded configuration.

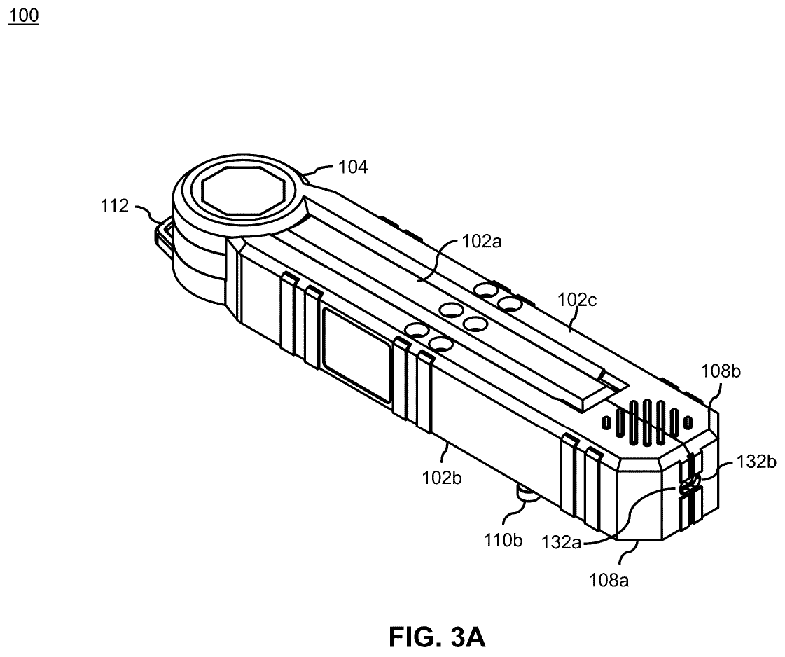

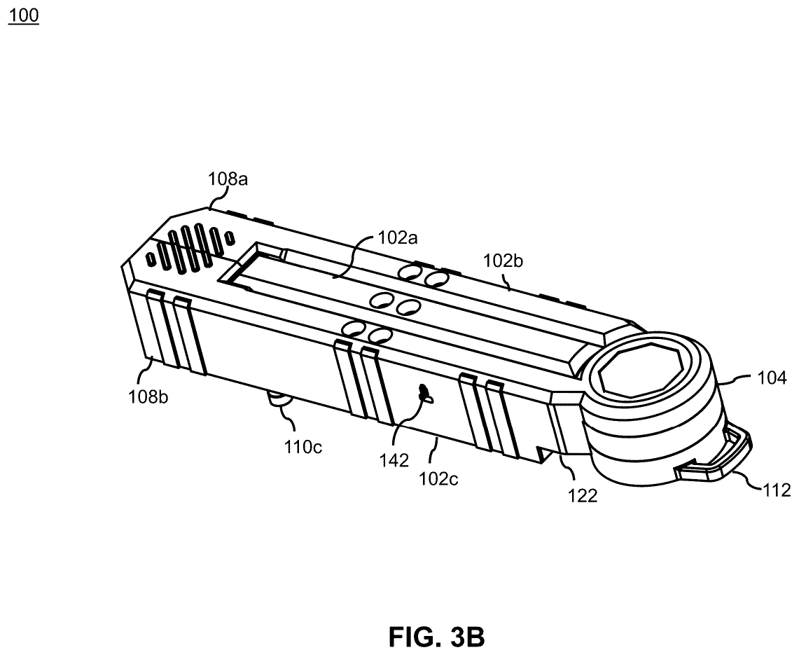

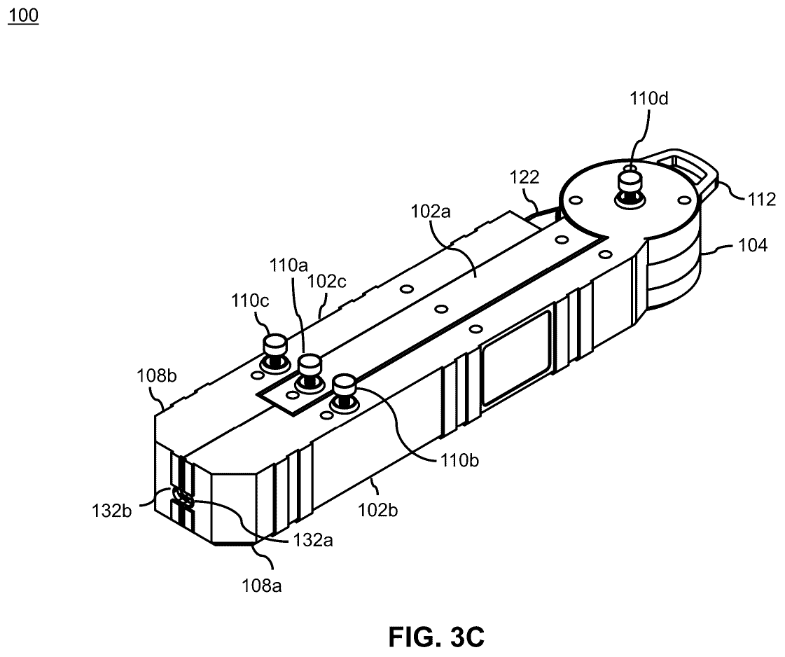

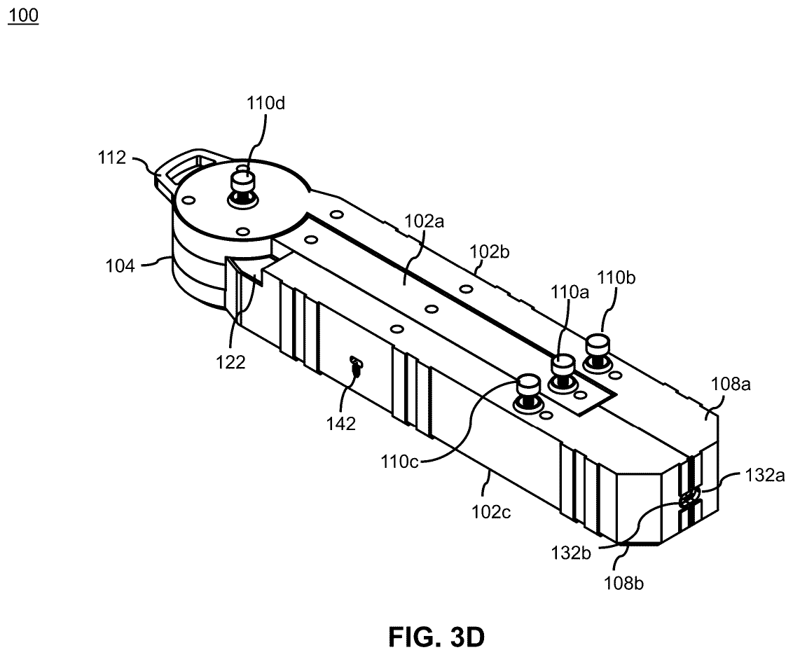

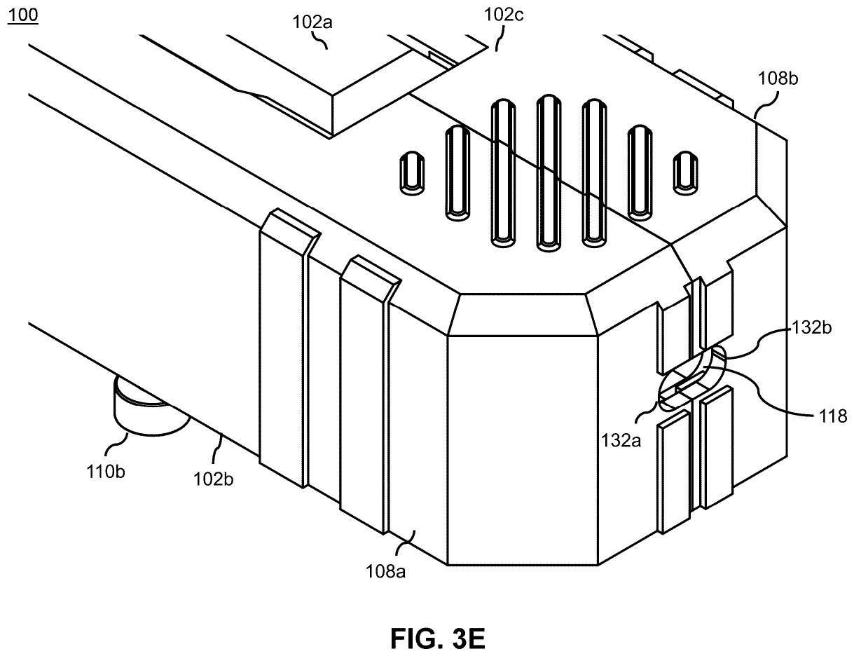

The folded configuration may also be referred to as a collapsed configuration, a transport configuration, or the like. The arm 102b and the arm 102c may abut the arm 102a in the folded configuration. FIGS. 3A-3E depict the foldable scale 100 in the folded configuration.

The arm 102b and the arm 102c may rotate about the center core 104 from the folded configuration away the arm 102a to unfold from the folded configuration to the unfolded configuration. Similarly, the arm 102b and the arm 102c may rotate about the center core 104 from the unfolded configuration towards the arm 102a to fold from the unfolded configuration to the folded configuration.

One or more of the arms 102 may include the control unit 106. For example, the arm 102a may include the control unit 106. The control unit 106 and the center core 104 may be disposed at opposing ends of the arms 102.

The control unit 106 may include a circuit board with one or more processors and memory. The processors may be configured to execute program instructions maintained on the memory, causing the processors to execute any of the various functions of the control unit 106.

The load cells 110 may extend from an underside of the arms 102 and/or the center core 104. The load cells 110 may support the entire weight of the foldable scale 100.

The foldable scale 100 may include the load cells 110 for each of the arms 102 and/or for the center core 104. For example, the load cells 110 may include load cell 110a, load cell 110b, load cell 110c, and load cell 110d. The load cell 110a, load cell 110b, load cell 110c, and load cell 110d may be referred to as a first load cell, a second load cell, a third load cell, and a fourth load cell, respectively. The load cell 110a, the load cell 110b, the load cell 110c, and the load cell 110d may extend from an underside of the arm 102a, the arm 102b, the arm 102c, and the center core 104, respectively.

The load cells 110 may include any sensor which may generate a weight measurement, such as, but not limited to, strain gauge load cells, capacitive load cells, or the like.

The load cells 110 may generate weight measurements. The weight measurements may indicate the weight on each of the respective of the load cells 110. The foldable scale 100 may be configured to weigh an object (e.g., object 704) using the load cells 110. The control unit 106 may receive the weight measurements from the load cells 110. The control unit 106 may add the weight measurements from the load cells 110 to generate a total weight measurement 124. The total weight measurement 124 may be the weight of the object on the foldable scale 100. The object being weighed does not need to be centered on the center core 104 to generate the total weight measurement 124. The foldable scale 100 may be configured to weigh objects with a total weight measurement 124 on the order of tens of grams, hundreds of grams, single digit kilograms and/or tens of kilograms. For example, the foldable scale 100 may be configured to weigh objects with a total weight measurement 124 of between 0.01 kilogram up to 45 kilograms or more.

The foldable scale 100 may generate the total weight measurement 124 when in the unfolded configuration and/or the partially unfolded configuration.

The load cells 110 may be magnetic. The load cells 110 may be configured to hold the weight of the foldable scale 100 by magnetically coupling to a ferromagnetic surface. The foldable scale 100 may be held to the ferromagnetic surface by the load cells 110 regardless of the orientation of the foldable scale 100. For example, the magnetic force provided by the load cells 110 may be larger than the weight of the foldable scale 100, allowing the load cells 110 to hold the foldable scale 100 flat, upright, upside down, or an angle therebetween.

The center core 104 may include the hook 112. The hook 112 may extend from the center core 104. The center core 104 and the hook 112 may be a rigid body. The foldable scale 100 may be configured to be suspended in an upright position using the hook 112 (e.g., when hooked to a nail or the like).

One or more of the arm 102b and/or the arm 102c may define a recessed portion 122 through which the hook 112 may travel when the foldable scale 100 is folded and unfolded. For example, the arm 102c may define the recessed portion 122. The recessed portion 122 may be disposed adjacent to the center core 104. The hook 112 may be disposed within the recessed portion 122 when the foldable scale 100 is in the folded configuration. The arm 102c may be configured to rotate about the center core 104 without interfering with the hook 112. The hook 112 may travel through the recessed portion 122 as the arm 102c rotates about the center core 104, thereby preventing the arm 102c from interfering with the hook 112.

One or more of the arms 102 may include the shrouds 108. For example, the arm 102b and the arm 102c may include the shroud 108a and the shroud 108b, respectively. The shrouds 108 and the center core 104 may be disposed at opposing ends of the arms 102. The shrouds 108 may abut when the foldable scale 100 is in the folded configuration. The shrouds 108 may cover the control unit 106 and/or the display 114 when the foldable scale 100 is in the folded configuration.

The control unit 106 and/or the shrouds 108 may include chamfer corners (as depicted), fillet corners (not depicted), or the like. For example, the control unit 106 may include an octagonal cross-section (as depicted), a circular cross-section (not depicted), or the like. The shape of the shrouds 108 may conform to the control unit 106. For example, the control unit 106 may include the octagonal cross-section which may be conformed to by the shrouds 108 having the chamfer corners.

The control unit 106 may include the display 114. The display 114 may include any suitable type of display. For example, the display 114 may include, but is not limited to, a liquid crystal display (LCD), an organic light-emitting diode (OLED) based display, or the like.

The display 114 may be configured to display various data, signals, or the like. For example, the display 114 may be configured to display the total weight measurement 124, a wireless connection indicator 126, a load-stable indicator 128, a warning indicator 130, a state-of-charge indicator 140, or the like.

The load-stable indicator 128 may indicate that a load on the load cells 110 is stable or unstable. For example, the load-stable indicator 128 may be solid when the load on the load cells 110 is stable and not moving. The control unit 106 may detect the load on the load cells 110 is stable and cause the display 114 to display the load-stable indicator 128 in response to the detection. For example, the control unit 106 may detect the load on the load cells 110 is stable within a tolerance after a hysteresis time and cause the display 114 to display the load-stable indicator 128.

The warning indicator 130 may provide one or more warnings. For example, the warning indicator 130 may provide a warning that the load on the load cells 110 is above capacity, one of the load cells 110 is damaged/disconnected, or the like. The control unit 106 may detect the load on the load cells 110 is above the capacity and/or that one of the load cells 110 is damaged/disconnected and cause the display 114 to display the load-stable indicator 128 in response to the detection.

The foldable scale 100 may include the batteries 116. The batteries 116 may provide power for the control unit 106, the load cells 110, the display 114, the sensor 120, the communication interface 134, and the like.

The batteries 116 may be disposed within the arms 102, center core 104, and/or the control unit 106. The batteries 116 are disposed within the arm 102a, the arm 102b, and the arm 102c. The batteries 116 may be disposed within the arms 102 between the load cells 110 and the center core 104. For example, the batteries 116 may be disposed within the arm 102a and/or the arm 102b.

The batteries 116 may include a state-of-charge. The state-of-charge may also be referred to as a power level or the like. The state-of-charge may be a level of charge of the batteries 116 relative to a capacity of the batteries 116. The state-of-charge may be measured as a percentage by the control unit 106. The state-of-charge indicator 140 may display the state-of-charge of the batteries 116. The control unit 106 may detect the state-of-charge and cause the display 114 to display the state-of-charge indicator 140 in response to the detection.

The batteries 116 be rechargeable. The batteries 116 may include any rechargeable battery, such as, but not limited to, lithium-ion polymer (LiPo) batteries.

The control unit 106 may include the charge port 118. The charge port 118 may be configured to recharge the batteries 116. For example, the charge port 118 may be configured to receive a charger for recharging the batteries 116. The charge port 118 may include, but is not limited to, a Universal Serial Bus (USB)™ charge port (e.g., a USB type-C charge port), or the like.

One or more of the arms 102 may define charge port recesses 132. For example, the arm 102b and the arm 102c may define a charge port recess 132a and a charge port recess 132b, respectively. The charge port recesses 132 may be defined through the shrouds 108. The charge port recesses 132 may be aligned with the charge port 118 when the foldable scale 100 is in the folded configuration. The charge port 118 may be configured to receive a charger through the charge port recesses 132 when the foldable scale 100 is in the folded configuration, enabling the batteries 116 to be recharged when the foldable scale 100 is in the folded configuration. The charge port recesses 132 may be beneficial for providing access to the charge port 118 while covering the remainder of the control unit 106 (e.g., to prevent damaging or scratching the control unit 106 by an external object when in the folded configuration).

The sensor 120 may include, but is not limited to, a reed switch, a hall switch, or the like. The sensor 120 may be disposed within the arms 102 and/or the control unit 106. For example, the sensor 120 may be disposed within the control unit 106.

The sensor 120 may detect when the foldable scale 100 is configured in the folded configuration and/or unfolded from the folded configuration (e.g., the unfolded configuration and/or the partially unfolded configuration). For example, the sensor 120 may detect when the arm 102c is disposed adjacent to the control unit 106 such that the arm 102c is in the folded configuration and/or detect when the arm 102c is not disposed adjacent to the control unit 106 such that the arm 102c is unfolded from the folded configuration.

The sensor 120 may provide an auto-on and/or auto-off feature. The sensor 120 may cause the control unit 106 and/or the display 114 to automatically turn-off when the sensor 120 detects the foldable scale 100 is configured in the folded configuration (e.g., when the arm 102c is in the folded configuration) and automatically turn-on when the sensor 120 detects the foldable scale 100 is unfolded from the folded configuration (e.g., when the arm 102c is partially unfolded to a partially unfolded configuration or fully unfolded the unfolded configuration). Thus, at least the arm 102c must be unfolded from the arm 102a to power-on the control unit 106 and/or the display 114. The control unit 106 and/or the display 114 may power-on regardless of configuration of the arm 102b. The sensor 120 may be beneficial to reduce the battery consumption of the control unit 106 and/or the display 114 when in the folded configuration. The sensor 120 may cause the control unit 106 and/or the display 114 to turn-on when the sensor 120 detects the foldable scale 100 is unfolded from the folded configuration. The communication interface 134 may also initiate the wireless connection when the sensor 120 detects the foldable scale 100 is unfolded from the folded configuration.

Although the sensor 120 is described as providing the auto-on and/or auto-off feature, this is not intended as a limitation of the present disclosure. The sensor 120 may provide an auto-sleep mode and an auto-wake mode. The sensor 120 may cause the control unit 106 and/or display 114 to automatically go into a sleep state from a full power state when the sensor 120 detects the foldable scale 100 is configured in the folded configuration. The sensor 120 may also cause the control unit 106 and/or the display 114 to automatically go into the full power state from the sleep state when the sensor 120 detects the foldable scale 100 is unfolded from the folded configuration. The sleep state may be a lower power state than the full power state. The communication interface 134 may maintain the wireless connection when in the sleep state. The auto-sleep mode may allow a constant wireless connection regardless of whether the foldable scale 100 is in the folded configuration or the unfolded configuration and allow fast responsiveness when the foldable scale 100 is unfolded from the folded configuration.

The control unit 106 may include the communication interface 134. The communication interface 134 may include a wireless communication interface (e.g., RF coupling, IR coupling, data network communication (e.g., WiFi™, WiMax™, Bluetooth™ and the like). The communication interface 134 may thus include wireless-based interfaces employing GSM, GPRS, CDMA, EV-DO, EDGE, WiMAX™, 3G, 4G, 4G LTE, 5G, WiFi™ protocols, RF, LoRa, and the like. In embodiments, the communication interface 134 is Bluetooth™ Low Energy (e.g., Bluetooth™ Low Energy version 5.1).

The control unit 106 may be configured to transmit and/or receive various data using the communication interface 134. The control unit 106 may be configured to establish a wireless connection using the communication interface 134. For example, the control unit 106 may be configured to transmit the total weight measurement 124 to a computing device (e.g., computing device 702) using the communication interface 134.

The wireless connection indicator 126 may display a status of the communication interface 134. The status of the communication interface 134 may include, but is not limited to, the communication interface 134 is off, the communication interface 134 is in a pairing mode, the communication interface 134 has successfully paired, the communication interface 134 is connected, or the like. The wireless connection indicator 126 may blink and/or change colors to indicate any of the various statuses. For example, the wireless connection indicator 126 may include a Bluetooth™ connection indicator which may blink and/or change colors according to the statuses. The wireless connection indicator 126 may be solid when the connection is made and may be off when ready to pair. The control unit 106 may cause the display 114 to display the wireless connection indicator 126 in response to detecting the status of the communication interface 134.

The foldable scale 100 may include wiring 144. The wiring 144 may be disposed within the arms 102 and/or the center core 104. The wiring 144 may be routed within the arm 102b and/or the arm 102c, through the center core 104, through the arm 102a to the control unit 106. The arm 102b and the arm 102c may be configured to rotate about the center core 104 without pinching the wiring 144. The wiring 144 may connect the control unit 106, the load cells 110, the batteries 116, the charge port 118, and the like. For example, the wiring 144 may connect from the control unit 106 to the load cells 110, the batteries 116, and/or the charge port 118. For instance, the load cells 110, the batteries 116, and/or the charge port 118 may be connected to the control unit 106 via any suitable network wiring topology. The weight measurements from the load cells 110 may be communicated from the load cells 110 to the control unit 106 via the wiring 144. Power may be provided from the batteries 116 to the control unit 106 and/or the load cells 110 via the wiring 144. Power may be provided from the charge port 118 to the batteries 116 via the wiring 144 for recharging the batteries 116.

The foldable scale 100 may include wire guide disks 146. The wire guide disks 146 may be disposed in the center core 104. The wire guide disks 146 may include a slick surface, allowing the wiring 144 to slide easily along the wire guide surface and not to pinch, catch, rip, or become malformed when folding and unfolding the foldable scale 100 (e.g., when rotating the arm 102b and the arm 102c about the center core 104). Without a wire guide apparatus, the wiring may catch or be damaged on surfaces in the center core, such as edges of metal, screw heads, nuts, and other sharp surfaces as the wiring 144 slides around during frequent opening and closing operations. The wiring 144 may be routed within the center core 104 via the wire guide disks 146. The wire guide disks 146 may be concentric to the axis about which the arm 102b and the arm 102c rotate. The wire guide disks 146 may include, but are not limited to, a segmented annulus shape. The wiring 144 may be disposed within the inner diameter of the segmented annulus shape. The segmented portion of the segmented annulus shape may enable inserting and removing the wiring 144 to and from the inner diameter when assembling the foldable scale 100. In one example, the center core 104 may include a pair of the wire guide disks 146 (e.g., an upper and lower of the wire guide disks 146). The pair of the wire guide disks 146 may route the wiring 144 from the arm 102a to the arm 102b and the arm 102c respectively.

The control unit 106 may include one or more user interface elements. For example, the control unit 106 may include a user interface element 136, a user interface element 138, or the like. The user interface elements may be button-elements, touchscreen elements, or the like. The user interface elements may be disposed adjacent to and/or on the display 114. The user interface element 136 and the user interface element 138 may be referred to as a first user interface element and a second user interface element, respectively.

The user interface element 136 may be configured to zero the total weight measurement 124. Zeroing may also be referred to as taring. The weight of the foldable scale 100 may be removed from the total weight measurement 124 by zeroing. The user interface element 136 may cause the control unit 106 to zero the total weight measurement 124 received from the load cells 110 in response to the user interface element 136 being pressed.

The user interface element 136 may be configured to turn-on and turn-off the control unit 106. For example, the user interface element 136 may be held down to turn-on and turn-off the control unit 106. The user interface element 136 may cause the control unit 106 to turn-on and turn-off the control unit 106 in response to receiving the input of the user interface element 136. The control unit 106 may turn-on when the user interface element 136 is held down while turned-off, and vice versa. The user interface element 136 may be a dual function element by causing the control unit 106 to zero the total weight measurement 124 and by causing the control unit 106 to turn-on and turn-off based on whether the user interface element 136 is pressed or held down.

The user interface element 138 may be configured to change a unit of the total weight measurement 124. For example, the user interface element 138 may be configured to change the unit of the total weight measurement 124 between imperial and metric. The user interface element 138 may cause the control unit 106 to change the unit and the corresponding value of the total weight measurement 124 displayed on the display 114 in response to receiving the input of the user interface element 138.

One or more of the arms 102 may define a lock slot 142. For example, the arm 102c may define the lock slot 142. The lock slot 142 may also be referred to as a security slot, a Kensington™ Security slot, a K-slot, or the like. The lock slot 142 may be configured to receive a lock as part of an anti-theft system.

The control unit 106 may be configured to automatically zero the load cells 110 after the control unit 106 is turned on and the total weight measurement 124 is stable. For example, the control unit 106 may turn on automatically when the foldable scale 100 is unfolded from the folded configuration. The foldable scale 100 may then be placed onto a flat surface. The weight measurements measured by the load cells 110 may stabilize once the foldable scale 100 is placed onto the flat surface. The control unit 106 may detect that the weight measurements measured by the load cells 110 are stable. For example, the control unit 106 may detect that the weight measurements do not fluctuate beyond a threshold (e.g., plus or minus 0.02 kilograms). In response to detecting the weight measurements measured by the load cells 110 are stable, the control unit 106 may zero the weight measurements and/or display the load-stable indicator 128. The user interface element 136 may also re-zero the weight measurements after the control unit 106 zeroizes the weight measurements.

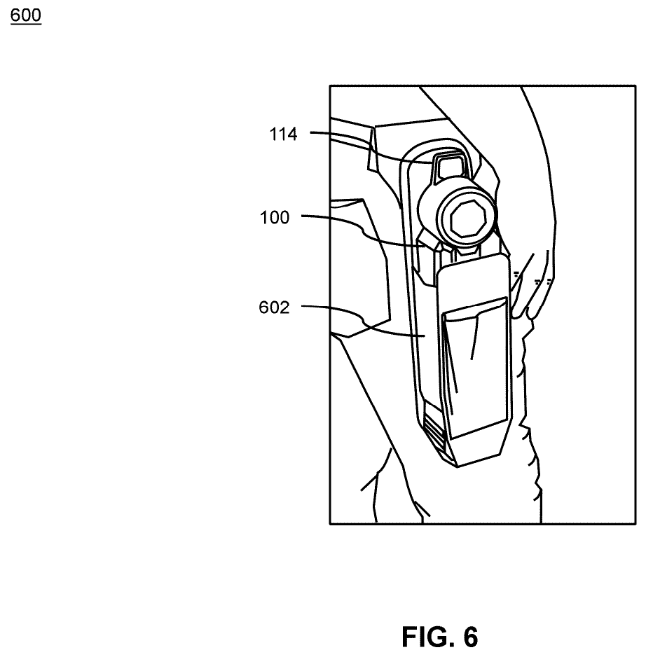

FIG. 6 depict a holstered scale 600, in accordance with one or more embodiments of the present disclosure. The holstered scale 600 may include the foldable scale 100 and a holster 602.

The holster 602 may include a belt-mount holster, a thigh-mount holster, or the like. The holster 602 may be a holster for the foldable scale 100. The foldable scale 100 may be holstered in the holster 602. The holster 602 may hold the foldable scale 100 when the foldable scale 100 is in the folded configuration.

The hook 112 of the foldable scale 100 may extend above the holster 602 when the holster 602 holds the foldable scale 100. The foldable scale 100 may be removable from the holster 602 via the hook 112 as the hook 112 may provide a path for a finger to be inserted and grab to pull the foldable scale 100 out of the holster 602.

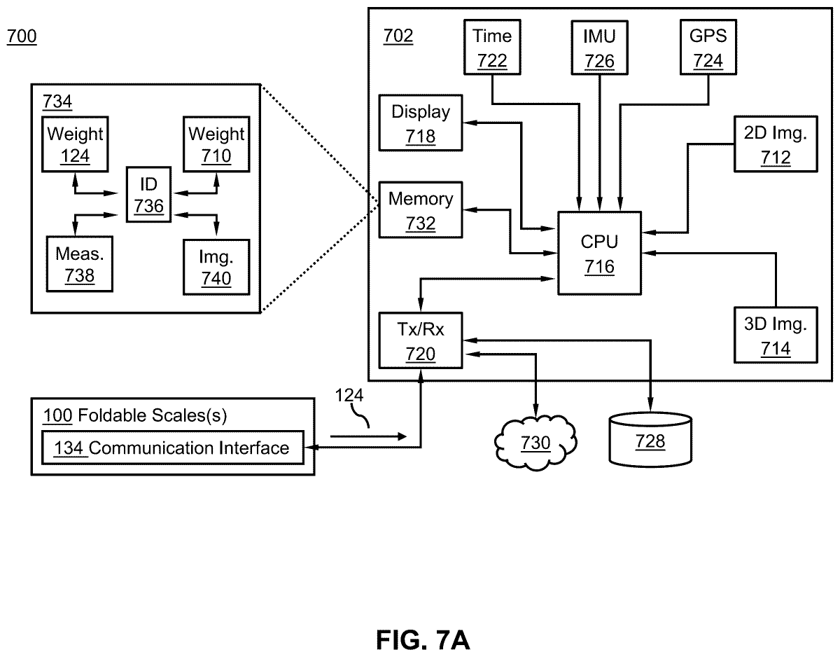

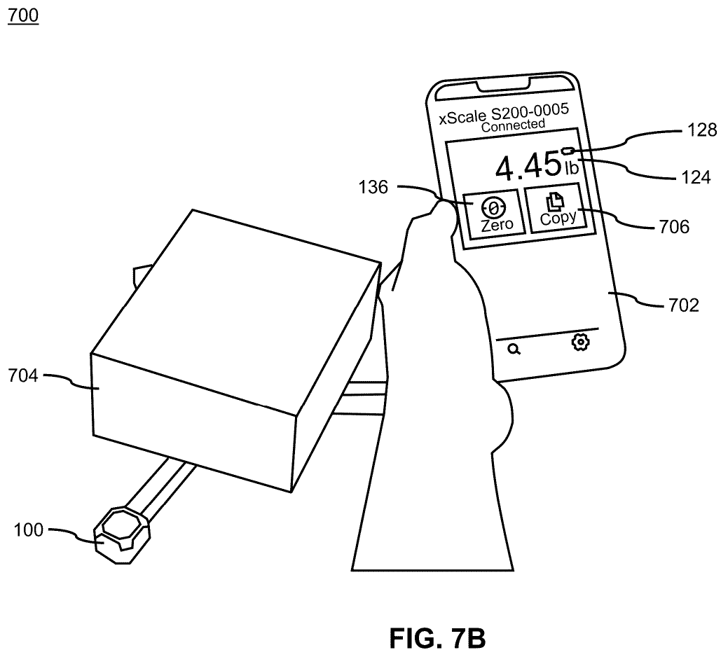

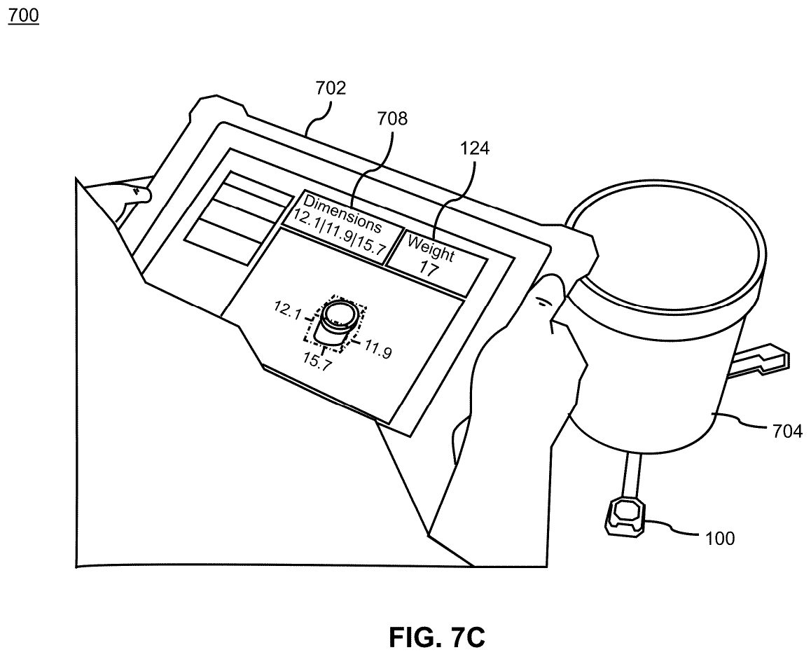

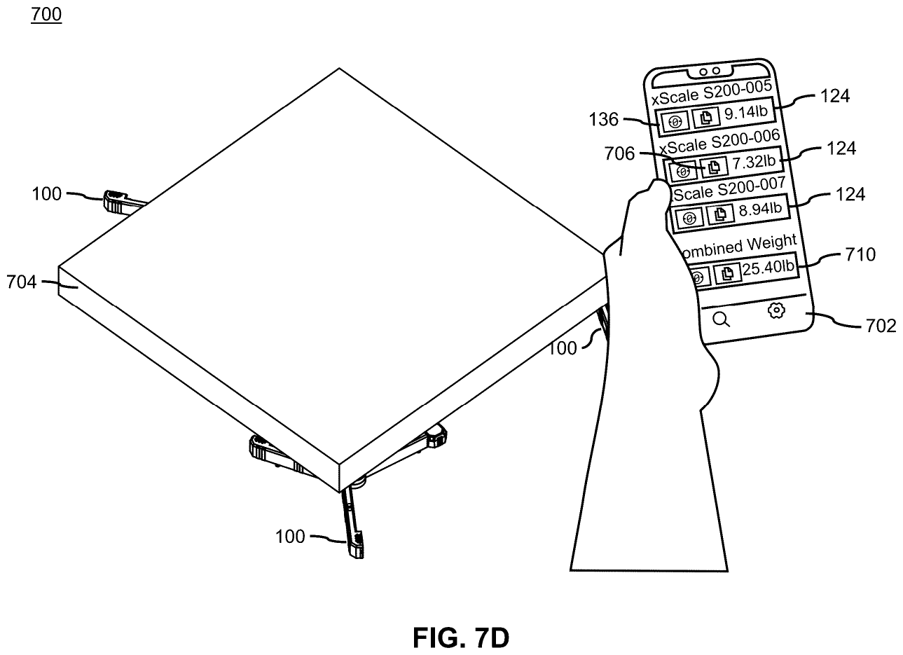

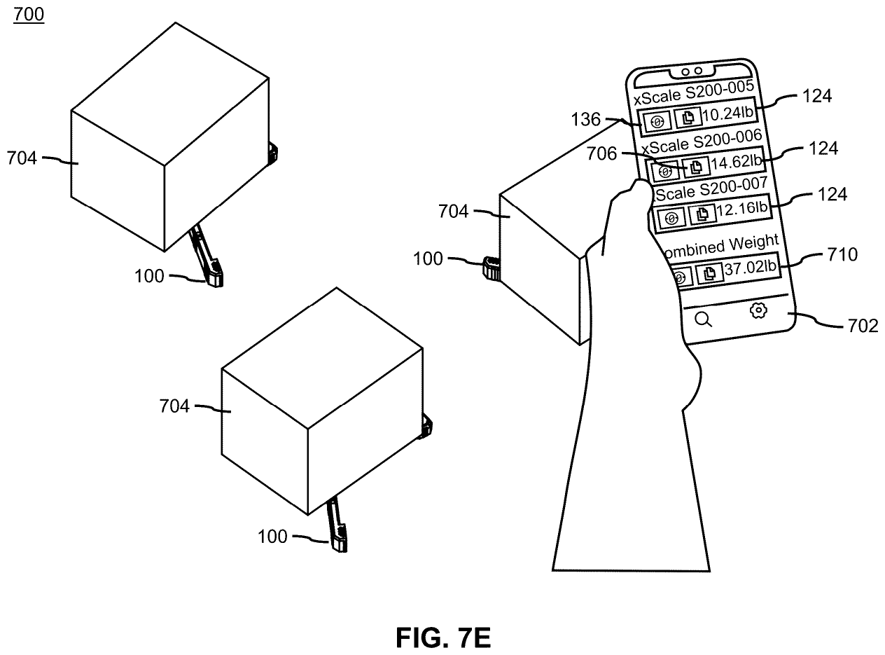

FIGS. 7A-7E depict a system 700, in accordance with one or more embodiments of the present disclosure. The system 700 may include the foldable scales 100, computing devices 702, and/or objects 704.

The computing devices 702 may include mobile devices, stationary devices, user equipment (e.g., a cell phone, tablet, etc.), desktop computers, workstations, or other computer devices.

The computing device 702 may include 2D image sensors 712 (e.g., a visible-light camera), 3D image sensors 714 (e.g., a 3D imager), processors 716 (e.g., a central processing unit), a touch-sensitive display surface 718, and a wireless transceiver 720. The computing device 702 may additionally include a clock 722 or time sensor, a Global Positioning System (GPS) receiver 724 or similar position sensor for determining a current position of the mobile device, and an inertial measurement unit 726 (IMU) or similar inertial sensor (e.g., accelerometer, magnetometer, gyrometer, compass) for determining a current orientation of the mobile device (or for tracking the orientation, and the rate of change thereof, over time). The inertial measurement unit 726 may be onboard the computing device 702, integrated into the 2D image sensors 712, integrated into the 3D image sensors 714, or the like. The 3D image sensors 714 may include imaging systems including infrared illuminators combined with multiple embedded cameras (e.g., Intel RealSense or other like triangulating systems), laser-based light detection and ranging (LIDAR) systems incorporating onboard photodetectors to track reflected beams and return distance information of the object 704, time of flight (ToF) camera systems, or any other like sensor system capable of producing 3D spatial information of proximate objects. As noted above, the 3D image sensors 714 may incorporate inertial or orientation sensors or combinations thereof, e.g., accelerometers, gyroscopes, and compasses. The 3D image sensors may include any suitable sensors for determining depth data of the target object, such as, but not limited to, distance sensors. For example, distance sensors may include sensors equipped to detect infrared radiation together with infrared or laser illuminators (e.g., light detection and ranging (LIDAR) systems. The computing device 702 may also include a memory 732 or other like means of data storage accessible to the processors 716.

The wireless transceiver 720 may enable the establishment of wireless links to remote sources, e.g., physical servers 728 and cloud-based storage 730. The foldable scales 100 may be configured to communicate with the computing devices 702 using the communication interface 134 and/or the wireless transceiver 720. For example, the foldable scales 100 and the computing devices 702 may pair using Bluetooth low energy™, or the like. The wireless transceiver 720 may also enable the establishment of wireless links to remote sources, e.g., physical servers 728 and cloud-based storage 730.

The computing devices 702 may be configured to receive the total weight measurement 124 from the foldable scales 100. The computing device 702 may be configured to receive the load cell data directly or the weight of each load cell separately, from the foldable scales 100. The computing device 702 may calculate the weight from the separate sensor data.

The computing devices 702 may include a user interface which may mirror the display 114. For example, the computing devices 702 may include a user interface which may display the total weight measurement 124, the wireless connection indicator 126, the load-stable indicator 128, the warning indicator 130, the state-of-charge indicator 140, or the like. The computing devices 702 may be configured to cause the control unit 106 to zero the total weight measurement 124, change the units, or the like. For example, the computing devices 702 may display the user interface element 136 by which the computing devices 702 may zero the total weight measurement 124 and/or turn-on and turn-off the foldable scale 100. By way of another example, the computing devices 702 may display the user interface element 138 by which the computing devices 702 may change the units of the total weight measurement 124.

The computing devices 702 may be configured to copy the total weight measurement 124 from the foldable scales 100 into the memory 732 of the computing devices 702. The computing devices 702 may include a user interface element 706. The user interface element 706 may copy the total weight measurement 124 into a clipboard buffer within the memory of the computing devices 702. The clipboard buffer may be a short-term memory which is common between all applications executed by the computing devices 702. The clipboard buffer may or may not maintain the total weight measurement 124 being power cycles of the computing devices 702. The clipboard buffer may reset when a new item is copied into the clipboard buffer. The total weight measurement 124 may then be pasted from the clipboard buffer. For example, the total weight measurement 124 may then be pasted from the clipboard buffer to any applications executed by the computing devices 702.

The computing devices 702 may be configured to scan a barcode of the objects 704 on the foldable scales 100. The total weight measurement 124 may be copied into memory 732 and associated with the data embedded within the barcode of the objects 704 being weighed by the foldable scales 100.

The computing devices 702 may be configured to generate a date, time, and/or geolocation. The computing devices 702 may associate the total weight measurement 124 with the date, time, and/or geolocation at which the computing devices 702 was located when the total weight measurement 124 was received from the foldable scales 100.

The computing devices 702 may execute object dimensioning software. For example, the computing devices 702 may execute object dimensioning software from MobileDemand™. The object dimensioning software may include box dimensioning software or the like. The computing devices 702 may be configured to determine dimensions 708 of the objects 704 supported by the foldable scales 100. In embodiments, the computing device 702 may be oriented toward the object 704 in such a way that the 3D image sensors 714 capture 3D imaging data from a field of view in which the object 704 is situated. For example, the object 704 may include a shipping box or container currently traveling through a supply chain, e.g., from a known origin to a known destination. The object 704 may be freestanding on the foldable scale 100, a floor, table, or other flat surface. The object 704 may be secured to a pallet or similar structural foundation, either individually or in a group of such objects, for storage or transport (as disclosed below in greater detail). The object 704 may be preferably substantially cuboid (e.g., cubical or rectangular cuboid) in shape, e.g., having six rectangular planar surfaces intersecting at right angles. In embodiments, the object 704 may not itself be perfectly cuboid but may fit perfectly within a minimum cuboid volume of determinable dimensions (e.g., the minimum cuboid volume necessary to fully surround or encompass the target object). Thus, both the dimensions 708 and total weight measurements 124 of the objects 704 may be measured using the system 700. The computing devices 702 may then associate the total weight measurement 124 with the dimensions 708 of the objects 704 in memory.

The system 700 may use multiple of the foldable scales 100 to weigh the objects 704 which may not fit onto one of the foldable scales 100. Each of the foldable scales 100 may generate the total weight measurements 124. The computing devices 702 may simultaneously connect to each of the foldable scales 100. The computing devices 702 may receive the total weight measurements 124 from each of the foldable scales 100 and sum the total weight measurements 124 to determine the weight of the objects 704. The objects 704 may include any bulky object which does not fit on the foldable scales 100, such as, but not limited to, televisions. Multiple of the foldable scales 100 may each report the weight of from one or multiple of the objects 704 at once. In this mode, the computing devices 702 may receive and calculates a combined weight 710 at once from two or more of the foldable scales 100 with one or more of the objects 704 to be weighed for the combined weight 710. For example, the computing devices 702 may determine the combined weight 710 for a shipment with multiple of the objects 704 by summing the total weight measurement 124 from multiple of the foldable scales 100 at once. By way of another example, the computing devices 702 may determine the combined weight 710 for a single of the objects 704 which is supported by multiple of the foldable scales 100 by summing the total weight measurement 124 from multiple of the foldable scales 100 at once. The software on the computing devices 702 may be in different modes, allowing Single Scale or Multiple scale input, such as Mode 1: Single scale, one or more items, Mode 2: Multiple scales, single item laying on each of the multiple scales, Mode 3: Multiple scales, multiple items. The Mode 3: Multiple scales, multiple items may or may not compute the combined weight 710.

The computing devices 702 may execute warehouse management software 734. Any of the total weight measurement 124, barcode, date, time, geolocation, and/or dimensions may be exported to the warehouse management software 734. The memory 732 may maintain the warehouse management software 734. The warehouse management software 734 may anchor data together using an identifier 736. The identifier 736 may include a serial number, a license plate number (i.e., license plate is description of a pallet identifier), stock keeping unit (SKU), product identifier (ID), or the like. The identifier 736 may be entered by keyboard input, reading RFID tag, scanning a barcode, optical character and icon recognition from a photo or video, or the like. The identifier 736 be associated with various data. For example, the identifier 736 may be associated with metrology data, such as the total weight measurement 124, the combined weight 710, dimension data 738, or the like. The association may be formed via a relational database, a unique identifier in filenames, tags, or other metadata associated and/or embedded within the digital records. The total weight measurements 124 and the dimension data 738 may be associated together in data records. Images 740 may also be associated with the identifier 736. The images 740 may be images from the 2D image sensors 712, from the 3D image sensors 714, from the camera 808, or the like. Any of the data, in whole or in part, may be stored, copy/pasted, or sent with an embedded tag or filename associated with a single or any combination of the identifier 736, date and time stamp, location, or the like.

The firmware and software in the foldable scale 100 may be updated through commands sent by software in the computing devices 702 attached through wireless or wired interface and communications. The computing devices 702 may query the firmware level state of the foldable scale 100 and compare that to any subsequently updated releases of the firmware. The software of the computing devices 702 may decide to prompt the user to update the software to continue to benefit from the latest features and/or bug fixes.

The software in the computing device 702 may guide the user through a calibration process to ensure reliable weight readings, as load cells and scales may need recalibration after time and use. The foldable scale 100 may particularly need recalibration as it is a mobile device itself, with possible drops and impacts that may cause the load cell metrological readings to be altered from the original calibration. An accelerometer in the foldable scale 100 may be embedded that can sense impact events, and thus the system will automatically alert of the impact event and possibly a recommendation or requirement to perform a calibration to ensure accurate weight readings. The calibration process may require one or multiple calibration weights to be applied to the scale surface and then automatic calibration data may be calculated and stored so the foldable scale will provide accurate weight data. If the calibration fails to be confident in the results, then the foldable scale 100 or software on the computing devices 702 may alert that a qualified service provider is required to fix the foldable scale 100 before weight measurements may be attained with certified accuracy.

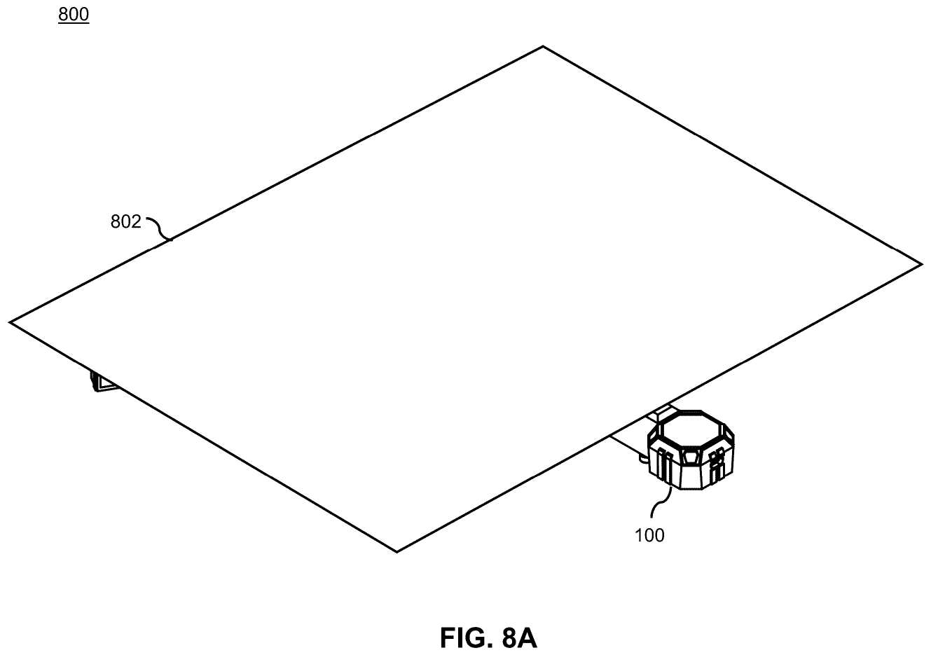

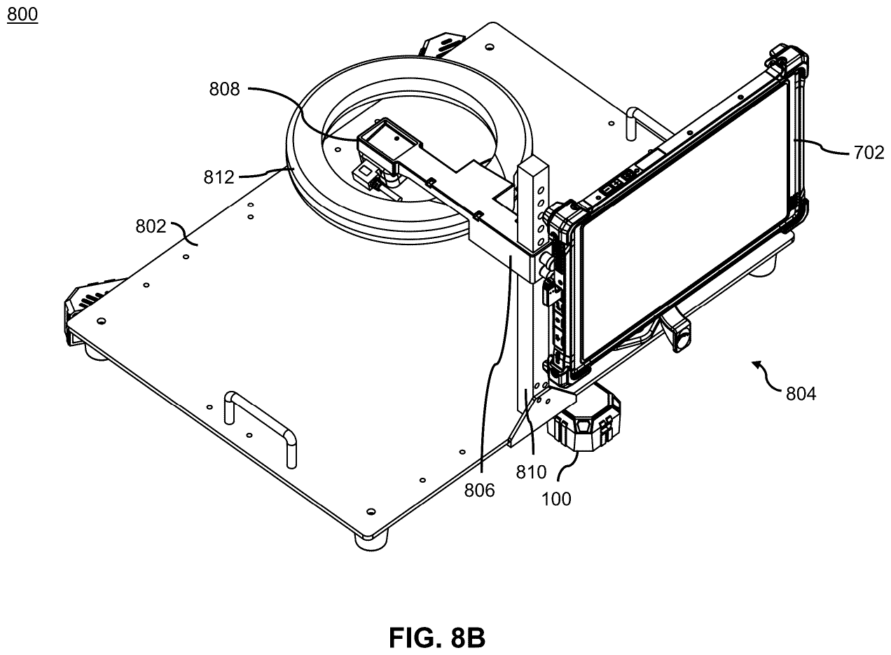

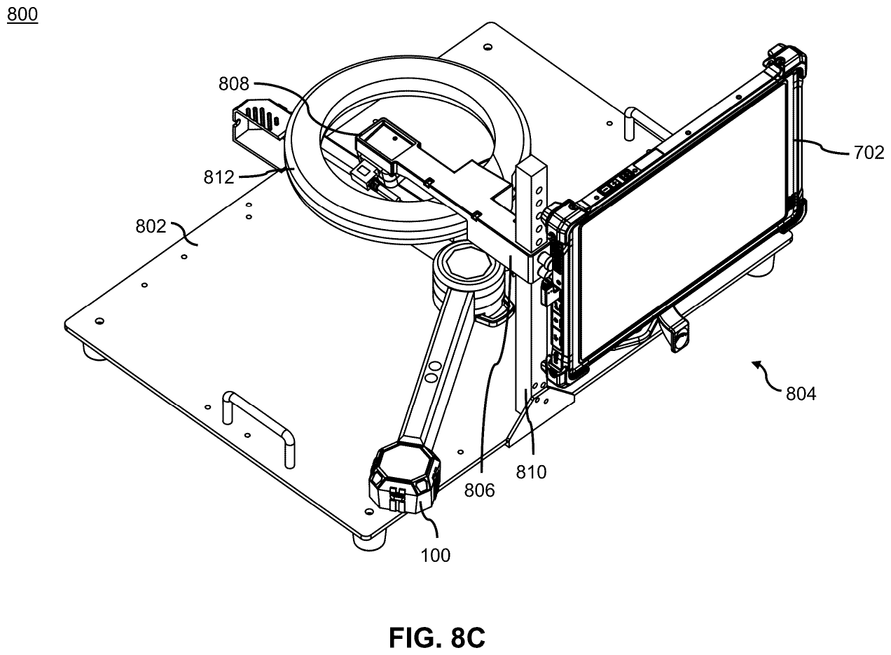

FIGS. 8A-8C depict a bench scale 800, in accordance with one or more embodiments of the present disclosure. The bench scale 800 may include the foldable scale 100, a platform 802, a dimensioning booth 804, and the like. The bench scale 800 may be used as a component of the system 700.

The platform 802 may be a plate, a tray, or the like. The platform 802 may be substantially planar, may include raised corners, or the like. The platform 802 may include a rectangular, square, circular, or another cross-section.

The platform 802 may be made of a select material, such as, but not limited to, plastic, metal, composite, or the like.

The platform 802 may be supported by the arms 102 and/or the center core 104. The platform 802 may include one or more bottom features (not depicted) which may align the platform 802 with the arms 102. For example, the bottom features may include ridges, dowels, or the like.

The display 114 may be visible while the foldable scale 100 supports the platform 802. For example, the display 114 may be visible for taring the weight of the platform 802 using the interface element 136.The weight of the platform 802 may be zeroed using the user interface element 136 to zero the weight of the platform 802 from the total weight measurement 124.

The platform 802 may support the objects 704. For example, the platform 802 may support one or more flexible objects. The foldable scale 100 may weigh the flexible objects. The platform 802 may allow supporting the flexible objects which would otherwise be difficult to weigh using the foldable scale 100. For example, the flexible objects may include clothing or the like.

The foldable scale 100 may be used in combination with the dimensioning booth 804. The dimensioning booth 804 may have special guiding features (not depicted) so the foldable scale 100 may be placed exactly into place. The dimensioning booth 804 may include the platform 802 onto which the foldable scale 100 may be placed. The objects 704 may then be placed on the platform 802 allowing smaller objects to be weighed by the foldable scale 100.

The dimensioning booth 804 may include a raised arm 806 and a post 810. The raised arm 806 may be configured to adjust in height relative to the platform 802 via the post 810. For example, the raised arm 806 and the post 810 may be coupled by a prismatic joint along which the raised arm 806 may linearly translate. The prismatic joint may be perpendicular to the platform 802. The raised arm 806 may be fixed at select position along the post 810 via one or more removeable pins. The raised arm 806 may include a camera 808. The camera 808 may be disposed above the platform 802. The platform 802 may be disposed within a field-of-view of the camera 808. The camera 808 may be configured to generate image data. For example, the camera 808 may be configured to generate 2D and/or 3D image data of the platform 802. The raised arm 806 may also include a light 812. The light 812 may illuminate the platform 802. The light 812 may include any suitable light, such as, but not limited to, a ring-shaped light.

The dimensioning booth 804 may also include the computing devices 702. The computing devices 702 may be affixed to the post 810. The computing devices 702 may execute the object dimensioning software using the 2D and/or 3D image data from the camera 808, to capture the dimensions of the object 704 inside the dimensioning booth 804. The dimension calculation may include a sized bounding box of the object 704.

Although the dimensioning booth 804 is described as placed on the foldable scale 100, this is not intended as a limitation of the present disclosure. In embodiments, the foldable scale 100 may be placed on the platform 802 of the dimensioning booth 804. Such arrangement may be beneficial to bring the object 704 placed on the foldable scale 100 closer to the camera 808. However, such arrangement may or may not allow weighing flexible objects.

Referring generally again to the figures. It is contemplated that all permutations of the foldable scale 100, the holstered scale 600, the holster 602, the system 700, the computing devices 702, the bench scale 800, the platform 802, the dimensioning booth 804, and the like may be used separately or in combination.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

Those having skill in the art will appreciate that there are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be affected, none of which is inherently superior to the other in that any vehicle to be utilized is a choice dependent upon the context in which the vehicle will be deployed and the specific concerns (e.g., speed, flexibility, or predictability) of the implementer, any of which may vary.

The previous description is presented to enable one of ordinary skill in the art to make and use the invention as provided in the context of a particular application and its requirements. As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period. For example, the memory may be random access memory (RAM), and the results may not necessarily persist indefinitely in the memory.

It is noted herein that the one or more components of system may be communicatively coupled to the various other components of system in any manner known in the art. For example, the one or more processors may be communicatively coupled to each other and other components via a wireline connection or wireless connection.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed:

1. A foldable scale comprising:
a plurality of arms comprising a first arm, a second arm, and a third arm;
a center core, wherein the plurality of arms extend from the center core, wherein the first arm is affixed to the center core, wherein the second arm and the third arm are configured to independently rotate about the center core between an unfolded configuration and a folded configuration, wherein the plurality of arms form a Y-shape in the unfolded configuration, wherein the second arm and the third arm are adjacent to the first arm in the folded configuration;
a plurality of load cells configured to generate a plurality of weight measurements, wherein the plurality of load cells extend from undersides of the plurality of arms and the center core;
one or more batteries; and
a control unit, wherein the control unit and the center core are disposed at opposing ends of the first arm, wherein the control unit is configured to receive the plurality of weight measurements and generate a total weight measurement from the plurality of weight measurements, wherein the control unit comprises a display, wherein the display is configured to display the total weight measurement.

2. The foldable scale of claim 1, comprising a hook, wherein the hook extends from the center core, wherein at least one of the second arm or the third arm defines a recessed portion through which the hook travels when the foldable scale is folded and unfolded.

3. The foldable scale of claim 1, wherein the plurality of load cells are magnetic, wherein the plurality of load cells are configured to hold the foldable scale by magnetically coupling to a ferromagnetic surface.

4. The foldable scale of claim 1, wherein the control unit is configured to cause the display to display a load-stable indicator in response to detecting a load on the plurality of load cells is stable.

5. The foldable scale of claim 1, wherein the control unit is configured to cause the display to display a warning indicator in response to detecting at least one of:
a load on the plurality of load cells is above capacity; or
at least one of the plurality of load cells is damaged or disconnected from the control unit.

6. The foldable scale of claim 1, wherein the control unit is configured to cause the display to display a state-of-charge of the one or more batteries in response to detecting the state-of-charge.

7. The foldable scale of claim 1, wherein the one or more batteries are rechargeable, wherein the control unit comprises a charge port configured to recharge the one or more batteries, wherein the second arm and the third arm define charge port recesses, wherein the charge port recesses are aligned with the charge port when the foldable scale is configured in the folded configuration.

8. The foldable scale of claim 1, comprising a sensor, wherein the sensor is configured to detect when the foldable scale is configured in the folded configuration and unfolded from the folded configuration, wherein the sensor is configured to cause the control unit to turn-off the display in response to detecting the foldable scale is configured in the folded configuration and turn-on the display in response to detecting the foldable scale is unfolded.

9. The foldable scale of claim 1, comprising a wireless communication interface, wherein the control unit is configured to establish a wireless connection with a computing device using the wireless communication interface.

10. The foldable scale of claim 1, comprising wiring and a wire guide disk, wherein the wiring connects the control unit, the plurality of load cells, and the one or more batteries, wherein the wire guide disk is disposed in the center core, wherein the wire guide disk routes the wiring within the center core, wherein the wire guide disk comprises a segmented annulus shape.

11. The foldable scale of claim 1, wherein the control unit comprises a first user interface element, wherein the first user interface element is configured to cause the control unit to zero the total weight measurement in response to the first user interface element being pressed, wherein the first user interface element is configured to turn-on and turn-off the control unit in response to the first user interface element being held.

12. The foldable scale of claim 1, wherein the control unit is configured to automatically zero the plurality of load cells in response to the control unit turning on and detecting the total weight measurement is stable.

13. A system comprising:
a foldable scale comprising:
a plurality of arms comprising a first arm, a second arm, and a third arm;
a center core, wherein the plurality of arms extend from the center core, wherein the first arm is affixed to the center core, wherein the second arm and the third arm are configured to independently rotate about the center core between an unfolded configuration and a folded configuration, wherein the plurality of arms form a Y-shape in the unfolded configuration, wherein the second arm and the third arm are adjacent to the first arm in the folded configuration;
a plurality of load cells configured to generate a plurality of weight measurements, wherein the plurality of load cells extend from undersides of the plurality of arms and the center core;
one or more batteries;
a control unit, wherein the control unit and the center core are disposed at opposing ends of the first arm, wherein the control unit is configured to receive the plurality of weight measurements and generate a total weight measurement from the plurality of weight measurements, wherein the control unit comprises a display, wherein the display is configured to display the total weight measurement; and
a wireless communication interface; and
a computing device, wherein the control unit is configured to establish a wireless connection with the computing device using the wireless communication interface by which the computing device is configured to receive the total weight measurement.

14. The system of claim 13, comprising a holster, wherein the holster is configured to hold the foldable scale when the foldable scale is in the folded configuration.

15. The system of claim 13, wherein the computing device is configured to copy the total weight measurement into a memory of the computing device.

16. The system of claim 15, wherein the computing device is configured to copy the total weight measurement into a clipboard buffer of the memory.

17. The system of claim 15, wherein the computing device is configured to scan a barcode of an object on the foldable scale, wherein the computing device is configured to copy the total weight measurement into memory associated with data embedded within the barcode of the object.

18. The system of claim 13, wherein the computing device is configured to associate the total weight measurement with at least one of a date, a time, or a geolocation at which the computing device was located when the total weight measurement was received from the foldable scale.

19. The system of claim 13, wherein the computing device is configured to execute object dimensioning software which is configured to determine one or more dimensions of an object on the foldable scale.

20. The system of claim 13, comprising a plurality of foldable scales, wherein the foldable scale is one of the plurality of foldable scales, wherein the plurality of foldable scales are configured to communicate with the computing device, wherein the computing device is configured to receive total weight measurements from each of the plurality of foldable scales.

21. The system of claim 20, wherein the computing device is configured to sum the total weight measurements to calculate a combined weight.

22. A bench scale comprising:
a foldable scale comprising:
a plurality of arms comprising a first arm, a second arm, and a third arm;
a center core, wherein the plurality of arms extend from the center core, wherein the first arm is affixed to the center core, wherein the second arm and the third arm are configured to independently rotate about the center core between an unfolded configuration and a folded configuration, wherein the plurality of arms form a Y-shape in the unfolded configuration, wherein the second arm and the third arm are adjacent to the first arm in the folded configuration;
a plurality of load cells configured to generate a plurality of weight measurements, wherein the plurality of load cells extend from undersides of the plurality of arms and the center core;
one or more batteries; and
a control unit, wherein the control unit and the center core are disposed at opposing ends of the first arm, wherein the control unit is configured to receive the plurality of weight measurements and generate a total weight measurement from the plurality of weight measurements, wherein the control unit comprises a display, wherein the display is configured to display the total weight measurement; and
a platform, wherein the platform is supported by the plurality of arms and the center core.

23. The bench scale of claim 22, comprising a dimensioning booth, wherein the dimensioning booth comprises the platform, a raised arm, and a post, wherein the raised arm is configured to adjust in height relative to the platform via the post, wherein the raised arm comprises a camera, wherein the platform is disposed within a field-of-view of the camera.
